(19) United States
(12) Patent Application Publication
(10) Pub. No.: US 2024/0389056 A1
(43) Pub. Date: Nov. 21, 2024

(54) INTELLIGENT BEAM PREDICTION METHOD, APPARATUS, AND DEVICE

(71) Applicant: Lenovo (Beijing) Limited, Beijing (CN)

(72) Inventors: Chuang ZHANG, Beijing (CN); Bingchao LIU, Beijing (CN)

(21) Appl. No.: 18/650,872

(22) Filed: Apr. 30, 2024

(30) Foreign Application Priority Data
May 16, 2023 (CN) 202310552603.1

(51) Int. Cl. H04W 64/00; H04B 17/318; H04W 16/28; H04W 24/02

(52) U.S. Cl. CPC H04W 64/00; H04B 17/328; H04W 16/28; H04W 24/02

(57) ABSTRACT

An intelligent beam prediction method includes obtaining an environment image, the environment image including environmental location information of a base station and a terminal, based on the environmental location information in the environment image, determining obstacle information on a direct path from the base station to the terminal, in response to the obstacle information indicating that an obstacle exists on the direct path, determining a target edge point of the obstacle, based on the target edge point, determining an emission angle, an incidence angle, and a propagation distance of a target beam between the base station and the terminal, and based on the emission angle, the incidence angle, and the propagation distance of the target beam, determining a target beam direction.

### CROSS-REFERENCE TO RELATED APPLICATION

The present disclosure claims priority to Chinese Patent Application No. 202310552603.1, filed on May 16, 2023, the entire content of which is incorporated herein by reference.

### TECHNICAL FIELD

The present disclosure relates to the intelligent beam prediction field and, more particularly, to an intelligent beam prediction method, an intelligent beam prediction apparatus, and an intelligent beam prediction device.

### BACKGROUND

Wireless massive Multiple-Input Multiple-Output (MIMO) technology significantly enhances the capacity of communication systems. In a high-frequency scenario, an intelligent beam that is more accurate and cost-effective is a key point for achieving a greater increase in the capacity of future 6G communication systems. However, as the number of beams increases, the cost generated by globally scanning and measuring all beams is enormous and is not acceptable in an actual system.

### SUMMARY

An aspect of the present disclosure provides an intelligent beam prediction method. The method includes obtaining an environment image, the environment image including environmental location information of a base station and a terminal, based on the environmental location information in the environment image, determining obstacle information on a direct path from the base station to the terminal, in response to the obstacle information indicating that an obstacle exists on the direct path, determining a target edge point of the obstacle, based on the target edge point, determining an emission angle, an incidence angle, and a propagation distance of a target beam between the base station and the terminal, and based on the emission angle, the incidence angle, and the propagation distance of the target beam, determining a target beam direction.

An aspect of the present disclosure provides an intelligent beam prediction system, including a processor, an emitter, and a receiver. The processor is configured to obtain an environment image, the environment image including environmental location information of a base station and a terminal, based on the environmental location information in the environment image, determine obstacle information on a direct path from the base station to the terminal, in response to the obstacle information indicating that an obstacle exists on the direct path, determine a target edge point of the obstacle, based on the target edge point, determine an emission angle, an incidence angle, and a propagation distance of a target beam between the base station and the terminal, and based on the emission angle, the incidence angle, and the propagation distance of the target beam, determine a target beam direction. The emitter is configured to emit the target beam based on the target beam direction. The receiver is configured to receive the target beam.

### BRIEF DESCRIPTION OF THE DRAWINGS

FIG. 1 illustrates a schematic flowchart of an intelligent beam prediction method according to some embodiments of the present disclosure.

FIG. 2 illustrates a schematic flowchart of a massive antenna technology according to some embodiments of the present disclosure.

FIG. 3 illustrates a schematic flowchart showing an analysis of an environment image according to some embodiments of the present disclosure.

FIG. 4 illustrates a schematic flowchart showing an analysis of beam strength information according to some embodiments of the present disclosure.

FIG. 5 illustrates a schematic flowchart showing another analysis of beam strength information according to some embodiments of the present disclosure.

FIG. 6 illustrates a schematic flowchart showing another analysis of beam strength information according to some embodiments of the present disclosure.

FIG. 7 illustrates a schematic flowchart showing data pre-processing of an intelligent beam prediction method according to some embodiments of the present disclosure.

FIG. 8A illustrates a schematic flowchart showing processing of another environment image according to some embodiments of the present disclosure.

FIG. 8B illustrates a schematic flowchart showing processing of an environment image according to some embodiments of the present disclosure.

FIGS. 9A to 9E illustrate schematic flowcharts showing processing of edge information according to some embodiments of the present disclosure.

FIG. 10A illustrates a schematic flowchart showing model training of an intelligent beam prediction method according to some embodiments of the present disclosure.

FIG. 10B illustrates a schematic flowchart showing another model training of an intelligent beam prediction method according to some embodiments of the present disclosure.

FIG. 10C illustrates a schematic flowchart showing another model training of an intelligent beam prediction method according to some embodiments of the present disclosure.

FIG. 11 illustrates a schematic flowchart showing an actual deployment of an intelligent beam prediction method according to some embodiments of the present disclosure.

### DETAILED DESCRIPTION OF THE EMBODIMENTS

Described embodiments are used to explain not limit the present disclosure.

In the subsequent descriptions, suffixes such as “module,” “component,” or “unit” representing elements are merely used to describe the present disclosure and do not have specific meaning. Thus, “module,” “component,” or “unit” can be used interchangeably.

An electronic device can include various forms. For example, the electronic devices of the present disclosure can include a mobile electronic device such as a Personal Digital Assistant (PDA), a navigation device, and a wearable device, as well as a fixed electronic device capable of performing fingerprint collection such as a digital TV, a desktop computer, etc.

In the following description, a mobile device or a base station device is taken as an example for description. Those skilled in the art can understand that, except for elements specific for moving purposes, the structure of embodiments of the present disclosure can also be applied to an electronic device of the fixed type.

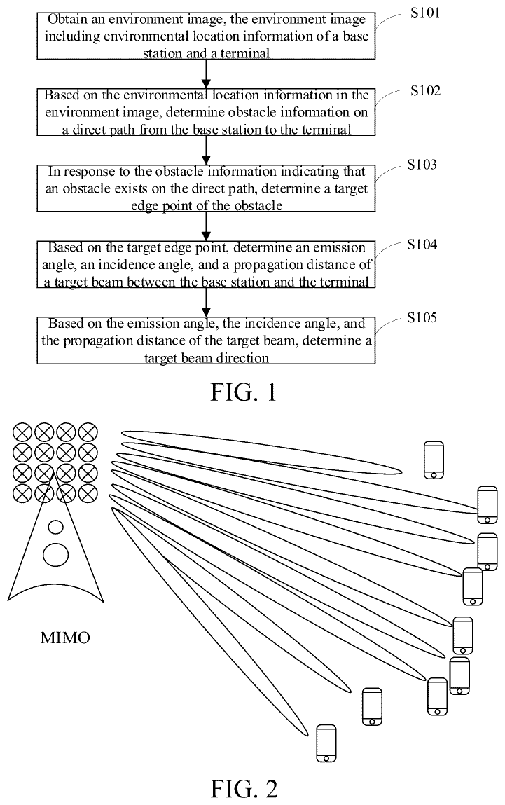

Based on this, embodiments of the present disclosure provide an intelligent beam prediction method. In the intelligent beam prediction method, different beam prediction strategies can be selected according to different scenarios. Non-Line-of-Sight (NLOS) can be converted into Line-of-Sight (LOS) to eliminate a sampling process and save resource consumption. By dividing the model, a large amount of data can be reused, and the trained model can be easy to migrate and have a fast execution speed and low resource consumption. In embodiments of the present disclosure, the intelligent beam prediction method can be executed by a processor of an intelligent beam prediction system. FIG. 1 illustrates a schematic flowchart of an intelligent beam prediction method according to some embodiments of the present disclosure. As shown in FIG. 1, the method includes step S101 to step S103.

At S101, an environmental image is obtained. The environmental image includes environmental location information of a base station and a terminal.

The environmental image can refer to an environmental image corresponding to the current base station and device. The environmental image can include the environmental location position of the base station and the terminal. The environmental location information can at least include location coordinates of the base station, location coordinates of the terminal, and locations of surrounding buildings. By obtaining the environment image, the location coordinates of the base station, the location coordinates of the terminal, and the locations of the surrounding buildings can be known.

In some embodiments, the environment image can be obtained through the input data or an image collection device.

At S102, based on the environmental location information in the environment image, obstacle information on a direct path between the base station and the terminal is determined.

The direct path can refer to a path corresponding to a straight line between the base station and the terminal. The obstacle information can be used to indicate whether an obstacle exists on the direct path, including where the obstacle exists or not. According to the analysis of the location coordinates of the base station, the location coordinates of the terminal, and the locations of the surrounding buildings, whether the obstacle such as a building exists on the direct path from the base station to the terminal can be determined.

In some embodiments, the obstacle information can be determined by analyzing the location information of the buildings in the environment image.

At S103, in response to the obstacle information indicating that the obstacle exists on the direct path, a target edge point is determined based on the obstacle.

The obstacle existing on the direct path can indicate that a transmission environment between the base station and the terminal is NLOS. A LOS path from the base station to the terminal can be determined by avoiding the obstacle through the target edge point. When the obstacle exists on the direct path between the base station and the terminal, the target edge point can be determined by performing calculations on the location information of the obstacle, the base station, and the terminal.

In some embodiments, a line segment function can be obtained through the location coordinates of the base station and the terminal to obtain all points that the line segment passes through. Whether all the points that the line segment passes through fall at the obstacle can be determined, i.e., whether the line segment is a LOS path can be determined.

At S104, based on the target edge points, an emission angle, an incidence angle, and a propagation distance of the target beam between the base station and the terminal are determined.

The emission angle, the incidence angle, and the propagation distance of the target beam between the base station and the terminal can be an emission angle, an incidence angle, and a propagation distance corresponding to the target beam. The beam information such as the emission angle, the incidence angle, and the propagation distance of the target beam between the base station and the terminal can be determined through the location information of the target edge points and in connection with the location information of the base station and the terminal.

At S105, based on the emission angle, the incidence angle, and the propagation distance of the target beam, the direction of the target beam is determined.

The target beam can be a strongest beam between the base station and the terminal. The direction of the target beam can be the direction of the strongest beam. In connection with the emission angle, the incidence angle, and the propagation distance of the target beam between the base station and the terminal, a specific direction of the target beam between the base station and the terminal can be determined.

In embodiments of the present disclosure, when the environment image between the base station and the terminal is obtained, whether the obstacle exists on the direct path between the base station and the terminal can be determined based on the environment image. When the obstacle exists, the emission angle, the incidence angle, and the propagation distance of the target beam between the base station and the terminal can be determined through the target edge points to determine the target beam direction. Thus, the target beam direction between the base station and the terminal can be determined through the environment image. Moreover, when the obstacle exists between the base station and the terminal, and the transmission environment between the base station and the terminal is NLOS, the target edge points can be determined through the analysis of the locations of the base station, the terminal, and the obstacle to convert the transmission environment between the base station and the terminal into LOS. Thus, the NLOS between the base station and the terminal can be converted into LOS to more accurately determine the emission angle, the incidence angle, and the propagation distance of the target beam between the base station and the terminal.

In some embodiments, after the emission angle, the incidence angle, and the propagation distance of the target beam between the base station and the terminal are determined based on the target edge points, the target beam direction can be accurately determined by analyzing whether the beam strength information between the base station and the terminal is obtained. That is, step S102 can include the following steps.

At S121, whether the beam strength information between the base station and the terminal is obtained can be determined.

The beam strength information can be obtained by sampling the beam between the base station and the terminal. After the emission angle, the incidence angle, and the propagation distance of the target beam between the base station and the terminal are determined through the information obtained from the environment image, whether the beam strength information between the base station and the terminal is simultaneously obtained can be determined through analysis.

At S122, in response to obtaining the beam strength information, the strength feature corresponding to the beam strength information is determined.

The corresponding strength feature can be extracted from the beam strength information between the base station and the terminal. Thus, when the beam strength information between the base station and the terminal is obtained, the corresponding strength feature can be determined by performing the feature extraction on the beam strength information.

In some embodiments, the strength feature can include an index of the strongest sampled beam between the base station and the terminal, a strongest sampled beam value, an index of a second strongest sampled beam, and a second strongest sampled beam value.

At S123, based on the emission angle, the incidence angle, and the propagation distance of the target beam, and the strength feature, the target beam direction is determined.

The emission angle, the incidence angle, and the propagation distance of the target beam determined according to the environment image can be combined with the strength feature determined according to the beam strength information to determine the target beam direction.

In embodiments of the present disclosure, when the environment image and the beam strength information between the base station and the terminal are provided, the emission angle, the incidence angle, and the propagation distance of the target beam determined according to the environment image can be combined with the strength feature determined according to the beam strength information to determine the target beam direction. Thus, by enriching the analysis data, the target beam direction can be more accurately determined to improve the accuracy of the target beam direction prediction.

In some embodiments, in step S105, determining the target beam direction can include the following steps.

Firstly, based on the emission angle, the incidence angle, and the propagation distance of the target beam, a horizontal direction of an emission beam, a vertical direction of the emission beam, and a reception beam of the target beam can be determined.

The horizontal direction of the emission beam can refer to a horizontal emission direction of the emission beam within the target beam. The vertical direction of the emission beam can refer to a vertical emission direction of the emission beam within the target beam. The reception beam can refer to a reception direction of the reception beam of the target beam. The horizontal direction of the emission beam, the vertical direction of the emission beam, and the reception direction of the reception beam of the target beam can be further determined through the emission angle, the incidence angle, and the propagation angle of the target beam.

Secondly, based on the horizontal direction of the emission beam, the vertical direction of the emission beam, and the reception direction of the reception beam, the target beam direction can be determined.

The target beam direction can be determined in connection with the horizontal direction of the emission beam, the vertical direction of the emission beam, and the reception direction of the reception beam.

In embodiments of the present disclosure, according to the emission angle, incidence angle, and propagation distance of the target beam, the horizontal direction of the emission beam, the vertical direction of the emission beam, and the reception direction of the reception beam in the target beam can be first determined. Then, according to the horizontal direction of the emission beam, the vertical direction of the emission beam, and the reception direction of the reception beam, the target beam direction can be further determined. Thus, the problem of finding the target beam from hundreds of beams can be divided into three separate problems of determining the strongest beams from the horizontal emission direction, the vertical emission direction, and the reception direction, respectively, to determine the target beam. By dividing the problem, the model generality can be improved, and the model can easily migrate. The strength feature of the beam strength information can be extracted more easily. The prediction data in the reception direction can be used universally in the horizontal emission direction and the vertical emission direction to improve the reusability of the data and save resource consumption.

In some embodiments, when the environment image is not obtained, an intelligent beam prediction can include the following steps.

Firstly, in response to not obtaining the environment image, the beam strength information between the base station and the terminal can be obtained.

When the environment image between the base station and the terminal is not obtained, sampling can be performed on the beams by scanning the beams between the base station and the terminal to obtain the beam strength information between the base station and the terminal.

Secondly, based on the strength feature corresponding to the beam strength information, the horizontal direction of the emission beam, the vertical direction of the emission beam, and the reception direction of the reception beam can be determined.

The corresponding strength feature can be determined by analyzing the beam strength information. According to the beam strength features of all the beams between the base station and the terminal included in the strength feature, a horizontal direction of the emission beam, a vertical direction of the emission beam, and a reception direction of the reception beam, in which the strength of the beam is the largest, can be determined as the horizontal direction of the emission beam, the vertical direction of the emission beam, and the reception direction of the reception beam in the target beam.

Thirdly, based on the horizontal direction of the emission beam, the vertical direction of the emission beam, and the reception direction of the reception beam, the target beam direction can be determined.

The horizontal direction of the emission beam, the vertical direction of the emission beam, and the reception direction of the reception beam can be combined to be determined as the direction of the target beam.

In embodiments of the present disclosure, when the environment image between the base station and the terminal is not obtained, and only the beam strength information is provided, the horizontal direction of the emission beam, the vertical direction of the emission beam, and the reception direction of the reception beam of the target beam can be determined by extracting the corresponding strength feature from the beam strength information. Through this method, when only the beam strength information is obtained, the target beam can be determined by extracting the strength feature. By dividing the problem, the model universality can be improved, and the model can easily migrate. The strength feature of the beam strength information can be extracted more easily after dividing the problem. In addition, the prediction data in the reception direction can be used universally in the horizontal emission direction and the vertical emission direction. Thus, the data reusability can be improved, and the resource consumption can be saved.

In some embodiments, when the obstacle information indicates that no obstacle exists on the direct path, the emission angle, the incidence angle, and the propagation distance of the target beam can be determined through the following process.

In response to the obstacle information indicating that no obstacle exists on the direct path, the emission angle, the incidence angle, and the propagation distance of the target beam can be determined based on the direct path.

When no obstacle exists on the direct path between the base station and the terminal, the transmission environment between the base station and the terminal can be indicated to be LOS. Thus, the emission angle, the incidence angle, and the propagation distance of the target beam can be directly determined according to the direct path.

In embodiments of the present disclosure, when no obstacle exists on the direct path between the base station and the terminal, the emission angle, the incidence angle, and the propagation distance of the target beam can be directly determined according to the direct path. Thus, the target beam direction can be determined, which eliminates the step of performing sampling on the beams between the base station and the device to obtain the beam strength information and saves resource consumption.

In some embodiments, in step S103, the target edge point can be determined through the following processes.

Firstly, based on the edge information of the obstacle, the edge point visible in a straight line from the base station and the terminal can be determined.

The edge information of the obstacle can be obtained through the edge of the obstacle in the environment image by the Laplace operator. By traversing the edge information, the edge point that is LOS for both the base station and the terminal can be determined. Then, the edge point visible in a straight line from the base station and the terminal can be determined through the edge information of the obstacle.

Secondly, based on the path information from each edge point to the base station and the terminal, the target edge point can be determined.

The path information can include the path from each edge point to the base station and the path from each edge point to the terminal. An optimal edge point can be determined as the target edge point through the paths.

In embodiments of the present disclosure, the edge point that is LOS for the base station and the terminal can be determined by analyzing the edge information of the obstacle between the base station and the terminal. According to the paths from each edge point to the base station and the terminal, the optimal edge point can be selected as the target edge point. According to the above method, in the NLOS transmission environment, the target edge point that can convert the NLOS into the LOS can be determined through the edge information of the obstacle to determine the emission angle, the incidence angle, and the propagation distance of the target beam between the base station and the terminal.

In some embodiments, in step S104, the emission angle, the incidence angle, and the propagation distance of the target beam can be determined through the following method.

Firstly, an angle from the base station to the target edge point is determined as the emission angle.

The angle corresponding to the connection line from the base station to the target edge point can be determined as the emission angle.

Secondly, an angle from the target edge point to the terminal is determined as the incidence angle.

The angle corresponding to the connection line from the target edge point to the terminal can be determined as the incidence angle.

Thirdly, a sum of a distance of the path from the base station to the target edge point and a distance of the path from the target edge point to the terminal is determined as the propagation distance.

The path from the base station to the target edge point and the path from the target edge point to the terminal can be determined. The sum of the distances of the paths can be determined as the propagation distance of the beam.

In embodiments of the present disclosure, the angle corresponding to the connection line from the base station to the target edge point can be determined as the emission angle, and the angle corresponding to the connection line from the target edge point to the terminal can be determined as the incidence angle. The sum of the distances of the paths from the base station to the target edge point and from the target edge point to the terminal can determined as the propagation distance of the beam. Thus, the target beam information can be determined to accurately determine the target beam direction.

In some embodiments, after the environment image is obtained, the environment image can be updated through the following method.

Firstly, the environment location information of the base station and the terminal can be detected.

After the environment image is obtained, the current environmental location information of the base station and the terminal corresponding to the current environment image can be detected in real time.

Secondly, when the environmental location information changes, the environment image can be updated based on the environmental location information.

When changes in the environmental location information corresponding to the base station and the terminal are detected, information of the user terminal such as the number and the location information can change, or the location information of the surrounding buildings of the base station and the terminal can change. Then, the environment image can be updated according to the current environmental location information to update the environment image in real time. The environment image can change as the environmental location information corresponding to the current base station and the terminal changes.

In some embodiments, when the requirement information of the user for the environment image is obtained, the current environmental location information can be detected according to the requirement information set by the user to update the environment image. The requirement information of the user can include a personalized requirement for images included in the environment image, and a requirement in a time interval for detecting the environmental location information. For example, when the requirement information set by the user can include updating the environment image every hour, the environmental location information of the base station and the terminal can be detected to update the environment image when the time length to the last time of updating the environment image reaches 1 hour.

In embodiments of the present disclosure, the corresponding environmental location information of the environment image can be updated in real time according to changes in the environmental location information of the current base station, terminal, and surrounding obstacles. With this method, the timeliness of the environment image can be improved, and inaccuracies in determining the target beam direction according to the environment image when the environmental location information changes can be reduced.

In some embodiments, in step S105, the target beam direction can be determined through the following steps.

Firstly, a horizontal direction model of the emission beam, a vertical direction model of the emission beam, and a reception beam mode can be received. The horizontal direction model of the emission beam, the vertical direction model of the emission beam, and the reception beam model can be updated based on the emission angle, the incidence angle, and the propagation distance of the sampled beam, and the strength feature corresponding to the beam strength information.

The horizontal direction model of the emission beam, the vertical direction model of the emission beam, and the reception beam model can be updated based on the emission angle, the incidence angle, and the propagation distance of the sampled beam, and the strength feature corresponding to the beam strength information. The horizontal direction model of the emission beam can be configured to predict a horizontal direction corresponding to a strongest beam in the horizontal directions of the emission beams. The vertical direction model of the mission beam can be configured to predict a vertical direction corresponding to the strongest beam in the vertical directions of the emission beams. The reception beam model can be configured to predict a reception direction corresponding to the strongest beam in the reception directions of the reception beams. The horizontal direction model of the emission beam, the vertical direction model of the emission beam, and the reception beam model can be trained by using the emission angle, the incidence angle, and the propagation distance of the extracted sampled beam and the strength feature corresponding to the beam strength information as the input data and using the horizontal direction of the emission beam, the vertical direction of the emission beam, and the reception direction of the reception beam as labels.

Secondly, the emission angle, the incidence angle, and the propagation distance of the target beam and/or the strength feature corresponding to the beam strength information can be input into the horizontal direction model of the emission beam, the vertical direction model of the emission beam, and the reception beam model, respectively, to obtain the horizontal direction of the emission beam, the vertical direction of the emission beam, and the reception direction of the reception beam.

The horizontal direction of the emission beam can be the horizontal direction corresponding to the beam strongest in the horizontal direction of all the emitted beams. The vertical direction of the emission beam can be the vertical direction corresponding to the beam strongest in the vertical direction of all the mitted beams. The reception direction can be a reception direction corresponding to the beam strongest in the reception direction of all the received beams. By inputting the emission angle, the incidence angle, and the propagation distance of the target beam and/or the strength feature corresponding to the beam strength information into the horizontal direction model of the emission beam, the vertical direction model of the emission beam, and the reception beam model to obtain the horizontal direction of the emission beam, the vertical direction of the emission beam, and the reception direction of the reception beam.

Thirdly, based on the horizontal direction of the emission beam, the vertical direction of the emission beam, and the reception direction of the reception beam, the target beam direction can be determined.

The target beam direction can be determined in connection with the determined horizontal direction of the mission beam, the vertical direction of the emission beam, and the reception direction of the reception beam.

In some embodiments, the horizontal direction corresponding to the beam strongest in the horizontal direction of all the emission beams can be determined through the horizontal direction model of the emission beam. The vertical direction corresponding to the beam strongest in the vertical direction of all the emission beams can be determined through the vertical direction model of the emission beam.

In embodiments of the present disclosure, by inputting the emission angle, the incidence angle, and the propagation distance of the target beam and/or the strength feature corresponding to the beam strength information into the horizontal direction model of the mission beam, the vertical direction model of the emission beam, and the reception beam model, respectively, to obtain the horizontal direction of the emission beam and the vertical direction of the emission beam. Thus, the target beam direction can be determined. Through the above method, the model of searching for the target beam from hundreds of beams can be divided into three models according to the horizontal direction model of the emission beam, the vertical direction model of the emission beam, and the reception beam model. The model versatility can be improved, and the model can migrate easily. The data in the reception beam model can be used in the horizontal direction model of the emission beam and the vertical direction model of the emission beam. Thus, the data reusability can be improved, and resource consumption can be saved.

The application of the intelligent beam prediction method of the present disclosure in the actual scenario can be described below. The beam between the base station and the terminal can be taken as an example for description.

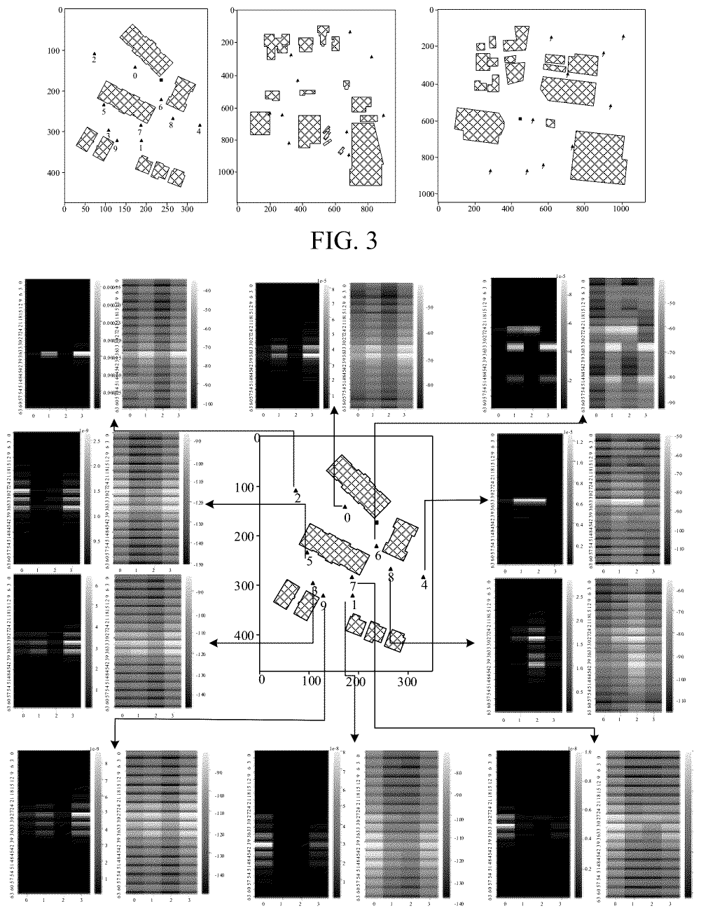

Deep fusion of communication and intelligent technology has become an important direction developed in the wireless communication system. For 6G, the angle and the depth of the communication fused with AI can be further extended. As shown in FIG. 2, the MIMO antenna technology significantly improves the capacity of the communication system. In a high-frequency scenario, forming an intelligent beam that is more accurate and lower cost can be the key to realize a larger increment in the capacity of the communication system for the future 6G. The correct MIMO beam selection can be based on the accurate beam measurement. As the number of beams increases, globally scanning all the beams and performing measurements on the beams can lead to a large cost, which is unacceptable in the actual system. For a more practical solution, scanning and measurement can be performed on sparse beams. Based on the measurement result, the other unmeasured beams can be pre-measured. Then, the strongest beam can be selected. How to achieve the most accurate beam prediction result with the given measurement cost through artificial intelligence (AI) technology is a very important research topic in future 6G communication.

In practical application, the beam prediction and model migration issues of the MIMO systems may need to be considered. The model migration can include migration between different carrier frequency systems and migration of the model from a general transmission environment dataset to a specific transmission environment. Environment migration can mean that the model can perform prediction on beams in various transmission environment scenarios. A transmission environment image can provide a layout of buildings in the scenario that generates the data. The migration of the carrier frequency system can refer to the migration between different carrier frequencies. The model is required to adapt to different carrier frequency systems.

In a first scenario, for a communication system with a carrier frequency of f1, a 64×4 beam pair set can include 64 emission beams and 4 reception beams. For each reception beam, 8 emission beams of the 64 emission beams can be scanned. Thus, 8×4 beam pair measurement results can be obtained. The data structure can include strengths of 64×4 beam pairs, a transmission environment image, a base station (BS) location, and a terminal (i.e., user equipment (UE)) location.

In a second scenario, for a communication system with a carrier frequency of f2, a 128×4 beam pair set can include 128 emission beams and 4 reception beams. For each reception beam, 8 emission beams of the 128 emission beams can be scanned. Thus, 8×4 beam pair measurement results can be obtained.

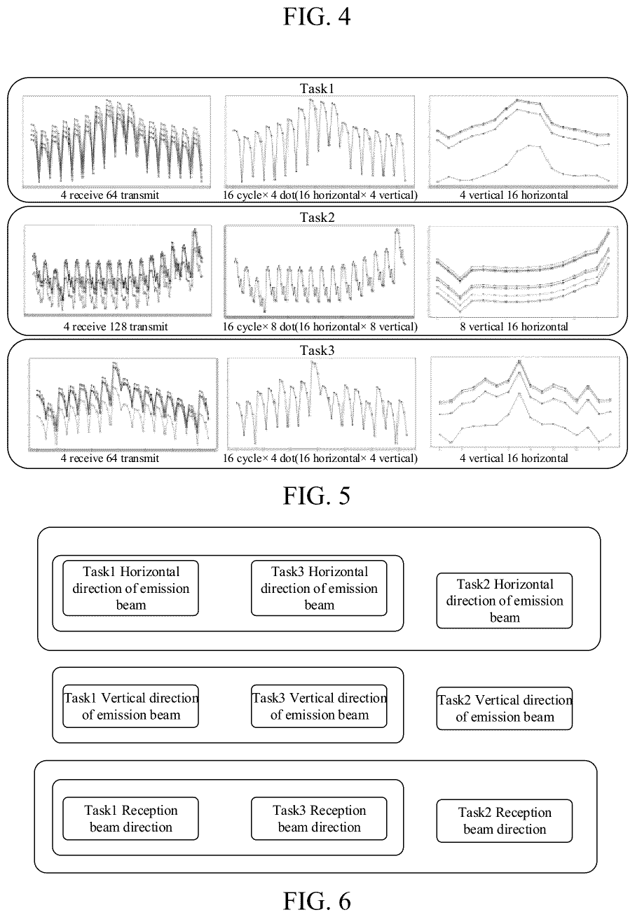

Since a building may or may not block between the base station and the terminal, the transmission environment can be an NLOS environment or an LOS environment. As shown in FIG. 3, a shaded area in the environment image represents a building, a square represents a base station, and a triangle represents a user terminal.

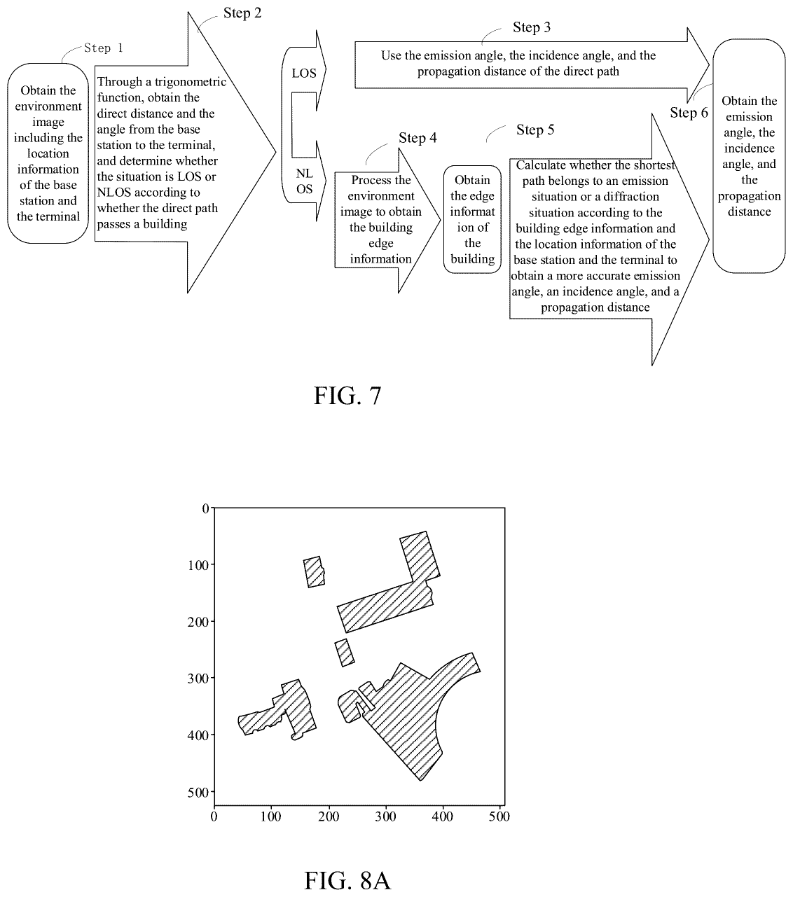

FIG. 4 illustrates a schematic diagram of beam strength information. The center includes the environment image information, including the location of the building, and the location coordinates of the base station and the terminal. Surrounding heat maps include strength information of the beams. Two maps are provided for each location and include a db value of an initial value on a right side, and a linearized value using 10**(dB/10) on a left side. Since the full set of 64×4 beams is too large, sampling can be performed on the beams in practical applications. The dataset can be sampled as 8×4. For example, for 64 emission directions and 4 reception directions, the base station can send 8 beams with the same strength to 8 directions of the 64 directions. The terminal can receive the 8 beams according to the 4 reception directions. Then, a strongest beam of the beams of the 64 directions when being emitted can be predicted and feedback to the base station. Subsequently, the base station can use the beam to send a signal to the terminal, and the terminal can receive the signal according to the strongest reception direction that is predicted.

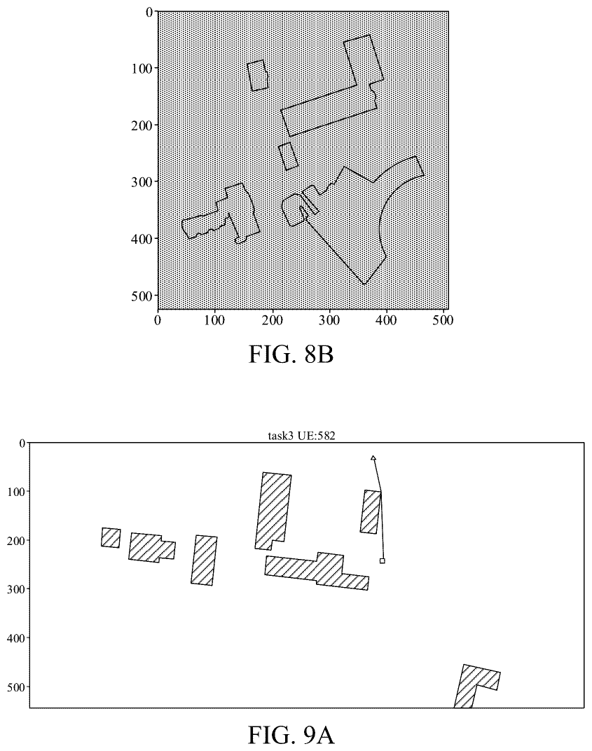

As shown in FIG. 5, by analyzing the beam information data under three scenarios (tasks), task1 and task3 each have horizontal directions of 16 beams and vertical directions of 4 beams, and task2 has horizontal directions of 16 beams and vertical directions of 8 beams. Thus, the three tasks are consistent in the horizontal directions of the beams.

In some embodiments, the spatial coordinates of the base station and the terminal can be converted into the angle and the distance from the base station to the terminal through a trigonometric function.

For LOS situations, the following conclusions can be drawn by analyzing the LOS situations.
1. The determination of the horizontal beam of the emission beam is mainly related to the emission angle from the base station to the terminal. This feature is the strongest feature and is not affected by the carrier frequency. That is, under different carrier frequencies, the horizontal beam of the emission beam can be determined by the same emission angle.
2. The determination of the vertical beam of the emission beam is mainly related to the propagation distance from the base station to the terminal, which is a strongest feature.
3. The determination of the reception beam is mainly related to the incidence angle from the base station to the terminal, and is not affected by the carrier frequency. That is, under different carrier frequencies, the reception beam can be determined by the same incidence angle.
4. The reception beam separated from the strongest beam direction is usually at the reception antenna with the largest value of the sampled beam. That is, by indexing the largest value of the sampled beam, the reception beam can be accurately determined.

For NLOS situations, the NLOS can be converted into the LOS for unified processing according to the environment image and the location information.

TABLE 1

| | | | | |
|---|---|---|---|---|
| 0 | z0 z8 z16 z24 | 1 | 2 | 3 |
| 1 | 4 | 5 | 6 | 7 |
| 2 | 8 | 9 | z1 z9 z17 z25 | 11 |
| 3 | 12 | 13 | 14 | 15 |
| 4 | 16 | z2 z10 z18 z26 | 18 | 19 |
| 5 | 20 | 21 | 22 | 23 |
| 6 | 24 | 25 | 26 | z3 z11 z19 z27 |
| 7 | 28 | 29 | 30 | 31 |
| 8 | z4 z12 z20 z28 | 33 | 34 | 35 |
| 9 | 36 | 37 | 38 | 39 |
| 10 | 40 | 41 | z5 z13 z21 z29 | 43 |
| 11 | 44 | 45 | 46 | 47 |
| 12 | 48 | z6 z14 z22 z30 | 50 | 51 |
| 13 | 52 | 53 | 54 | 55 |
| 14 | 56 | 57 | 58 | z7 z15 z23 z31 |
| 15 | 60 | 61 | 62 | 63 |

TABLE 2

| | | | | | | | | |
|---|---|---|---|---|---|---|---|---|
| 0 | ^{z0 z8 z16 z24} | 1 | 2 | 3 | 4 | 5 | 6 | 7 |
| 1 | 8 | 9 | 10 | 11 | 12 | 13 | 14 | 15 |
| 2 | 16 | 17 | ^{z1 z9 z17 z25} | 19 | 20 | 21 | 22 | 23 |
| 3 | 24 | 25 | 26 | 27 | 28 | 29 | 30 | 31 |
| 4 | 32 | 33 | 34 | 35 | ^{z2 z10 z18 z26} | 37 | 38 | 39 |
| 5 | 40 | 41 | 42 | 43 | 44 | 45 | 46 | 47 |
| 6 | 48 | 49 | 50 | 51 | 52 | 53 | ^{Z3 z11 z19 z27} | 55 |
| 7 | 56 | 57 | 58 | 59 | 60 | 61 | 62 | 63 |
| 8 | 64 | ^{Z4 z12 z20 z28} | 66 | 67 | 68 | 69 | 70 | 71 |
| 9 | 72 | 73 | 74 | 75 | 76 | 77 | 78 | 79 |
| 10 | 80 | 81 | 82 | ^{z5 z13 z21 z29} | 84 | 85 | 86 | 87 |
| 11 | 88 | 89 | 90 | 91 | 92 | 93 | 94 | 95 |
| 12 | 96 | 97 | 98 | 99 | 100 | ^{z6 z14 z22 z30} | 102 | 103 |
| 13 | 104 | 105 | 106 | 107 | 108 | 109 | 110 | 111 |
| 14 | 112 | 113 | 114 | 115 | 116 | 117 | 118 | ^{z7 z15 z23 z31} |
| 15 | 120 | 121 | 122 | 123 | 124 | 125 | 126 | 127 |

As shown in Table 1 and Table 2, according to the beam direction information data, the horizontal direction of each beam covers about 7.5 degrees, and 16 beams cover 120 degrees. The beams can repeat three times to cover the whole plane. The reception beam can be symmetrical about a horizontal axis. According to the analyzed beam direction information, the sampling strategy can be analyzed, including sampling one horizontal direction for every other one beam, and sampling one vertical direction for every other one beam. The difference can include that scenario 1 and scenario 3 each have 4 vertical directions, and scenario 2 has 8 vertical directions.

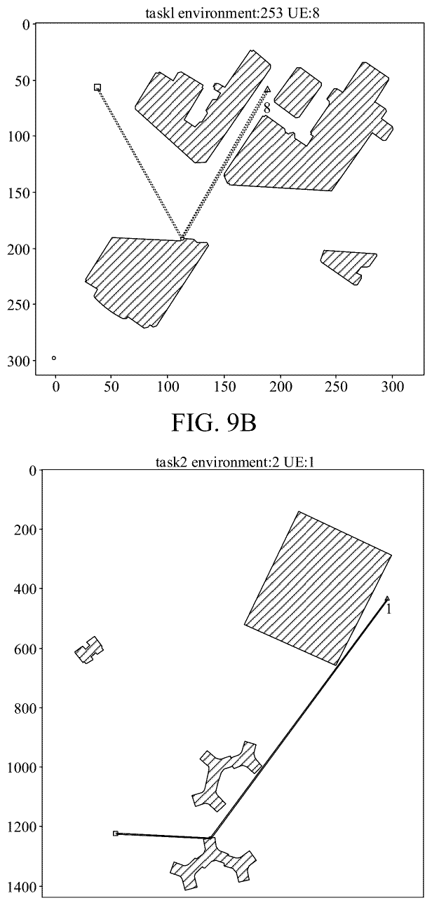

According to the above analysis, as shown in FIG. 6, the beam prediction problem can be divided into three problems of the horizontal beam of the emission beam, the vertical beam of the emission beam, and the reception beam. The horizontal beam model of the emission beam, the vertical beam model of the emission beam, and the reception beam model can be used to predict the horizontal beam of the emission beam, the vertical beam of the emission beam, and the reception beam, respectively. Then, the horizontal beam of the emission beam, the vertical beam of the emission beam, and the reception beam can be combined to obtain the target beam. The prediction model for task1 and task3 can be used universally. If only the emission angle and the propagation distance are used as the features, task2 can also share with the same prediction model. The direction of the reception beam can be predicted using the same prediction model if the largest value of the 8 beams of each reception direction is used as the feature. The application feature of the vertical direction of the emission beam can include a

largest value of the four beams of the reception direction at the same position of the 8 sampled emission beams, an index of the strongest beam that is sampled, a value of the strongest beam that is sampled, an index of a second strongest beam that is sampled, a value of the second strongest beam that is sampled, the emission angle, the propagation distance, etc. When the application feature includes the emission angle and the propagation distance, task1 and task 3 can share the same prediction model.

The application feature of the horizontal direction of the emission beam can include a largest value of the 4 beams of the reception direction at the same position of the 8 sampled emission beams, the index of the strongest beam that is sampled, the value of the strongest beam that is sampled, the index of a second strongest beam that is sampled, the value of the second strongest beam that is sampled, the emission angle, the propagation distance, etc. When the application feature includes the emission angle and the propagation distance, task1 and task 3 can share the same prediction model.

The application feature of the reception beam can include the incidence angle, the propagation distance, and the largest value of the 8 beams of the reception direction.

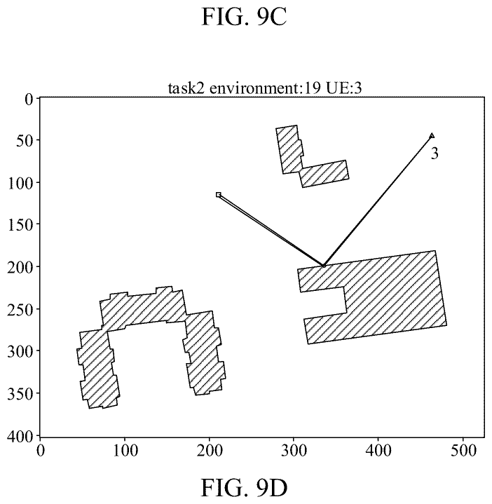

FIG. 7 illustrates a schematic flowchart showing data pre-processing of an intelligent beam prediction method according to some embodiments of the present disclosure. The method includes the following processes.

Firstly, the environment image including the location information of the base station and the terminal can be obtained.

Secondly, through a trigonometric function, the direct distance and the angle from the base station to the terminal can be obtained, and whether the situation is LOS or NLOS can be determined according to whether the direct path passes a building.

When the direct path does not pass the building, the transmission environment can be LOS, otherwise, the transmission environment can be NLOS.

Thirdly, in the LOS situation, the emission angle, the incidence angle, and the propagation distance of the direct path can be used.

Fourthly, in the NLOS situation, the environment image can be processed to obtain the building edge information.

Fifthly, the building edge information can be obtained. Whether the shortest path belongs to an emission situation or a diffraction situation can be calculated according to the building edge information and the location information of the base station and the terminal to obtain a more accurate emission angle, an incidence angle, and a propagation distance.

Sixthly, the emission angle, the incidence angle, and the propagation distance can be obtained.

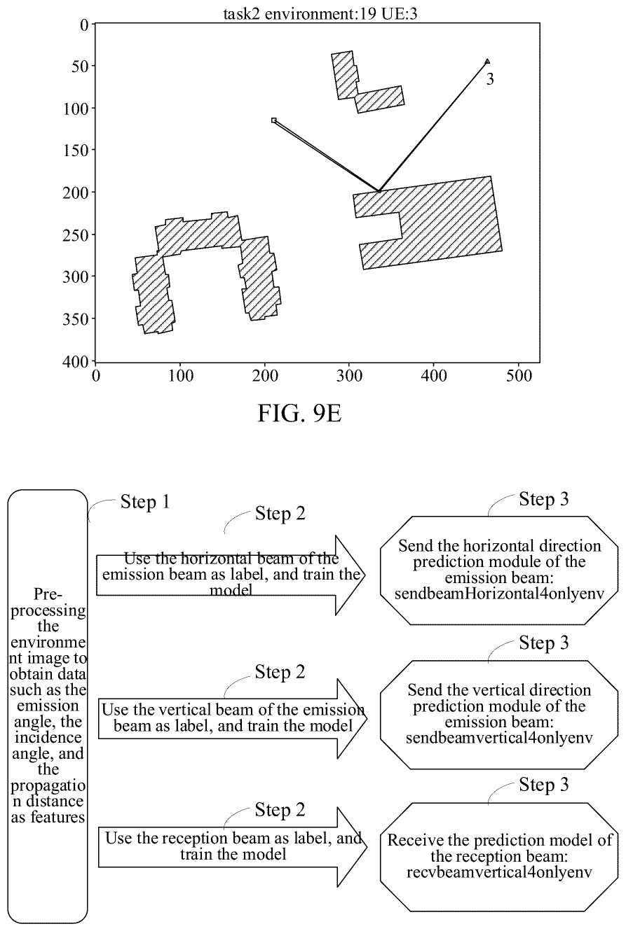

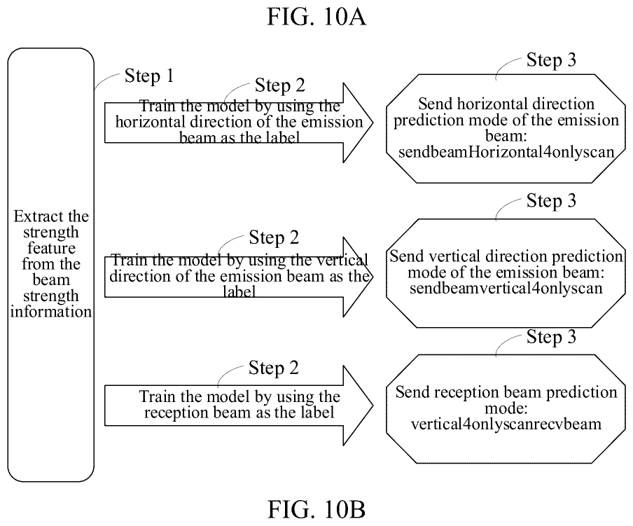

A plurality of methods can be used to process the environment image to obtain the obstacle edge information. For example, a Laplacian operator can be used for direct processing, which is fast with low resource consumption. In the environment image shown in FIG. 8A, the edge information of the buildings shown in FIG. 8B can be obtained through the processing using the Laplacian operator. As shown in FIGS. 9A to 9E, with different tasks, different environments, and different terminals (UEs), a reflection path or a diffraction path is calculated according to the building edge information. Thus, the emission angle and the incidence angle of the beam from the base station to the terminal can be determined more accurately in the NLOS situation.

The method of converting the NLOS situation into the LOS situation can include the following processes.

Firstly, the edge points of the building can be obtained using the Laplacian operator.

Secondly, traversing each edge point to find edge points as LOS for both the base station and the terminal, and the sum of the distances of the paths from these edge points to the base station and the terminal can be calculated.

Determining whether the edge point is as LOS for the base station and the terminal can include obtaining a line segment function according to the location coordinates of the starting point and the destination point. Thus, all the points that the line segment passes through can be obtained. Then, whether the points passed through by the line segment fall at the building can be determined.

Thirdly, an optimal edge point can be selected as the target edge point. An optimal path can be obtained according to the optimal edge point.

Fourthly, the angle from the base station to the target edge point can be used as the emission angle.

Fifthly, the angle from the target edge point to the terminal can be used as the incidence angle.

Sixthly, the propagation distance is the sum of the distances of the two LOS segments.

At S806, the emission angle, the incidence angle, and the propagation distance are obtained.

Model training can include three situations. In a first situation, only the environment image including the base station and the location information of the terminal is provided. In a second situation, only beam strength information between the base station and the terminal is provided. In a third situation, the environment image and the beam strength information are provided together. The model can be trained separately for the three situations.

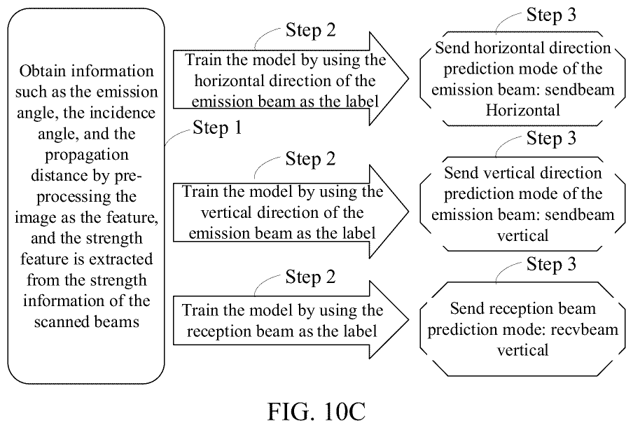

In the first situation, as shown in FIG. 10A, considering the reduction of the sampling cost, the training process can include the following steps for the situation of only providing the environment image and the location information of the base station and the terminal.

At step 1, the environment image is pre-processed to obtain data such as the emission angle, the incidence angle, and the propagation distance as features.

At step 2, the model is trained by using the horizontal beam of the emission beam as a label, the vertical beam of the emission beam as a label, and the reception beam as a label.

At step 3, the prediction model in the horizontal direction of the emission beam of sendbeamHorizontal4onlyenv, the prediction model in the vertical direction of the emission beam of sendbeamvertical4onlyenv, and the prediction model of the reception beam recvbeamvertical4onlyenv can be obtained.

In the second situation, as shown in FIG. 10B, when the environment information or the location information of the base station and the terminal are not able to be obtained, and only the scanned beam strength information is provided, the training process includes the following steps.

At step 1, the strength feature is extracted from the beam strength information.

At step 2, the model is trained by using the horizontal direction of the emission beam as the label, the vertical direction of the emission beam as the label, and the reception beam as the label.

At step 3, a prediction model in the horizontal direction of the emission beam of sendbeamHorizontal4onlyscan, a prediction model in the vertical direction of the emission beam of sendbeamvertical4onlyscan, and a prediction model of the reception beam of vertical4onlyscanrecvbeam are obtained.

The strength feature extracted from the beam strength information can include the largest beam strength value, a second largest beam strength value, an index of the largest beam strength value, an index of the second largest beam strength value, etc.

In the third situation, as shown in FIG. 10C, the environment image and the beam strength information are provided together, and the training process includes the following steps.

At step 1, information such as the emission angle, the incidence angle, and the propagation distance is obtained by pre-processing the image as the feature, and the strength feature is extracted from the strength information of the scanned beams.

At step 2, the model is trained by using the horizontal direction of the emission beam as the label, the vertical direction of the emission beam as the label, and the reception beam as the label.

At step 3, a prediction model in the horizontal direction of the emission beam of sendbeam Horizontal, a prediction model in the vertical direction of the emission beam of sendbeam vertical, and a prediction model of the reception beam of recvbeam vertical are obtained.

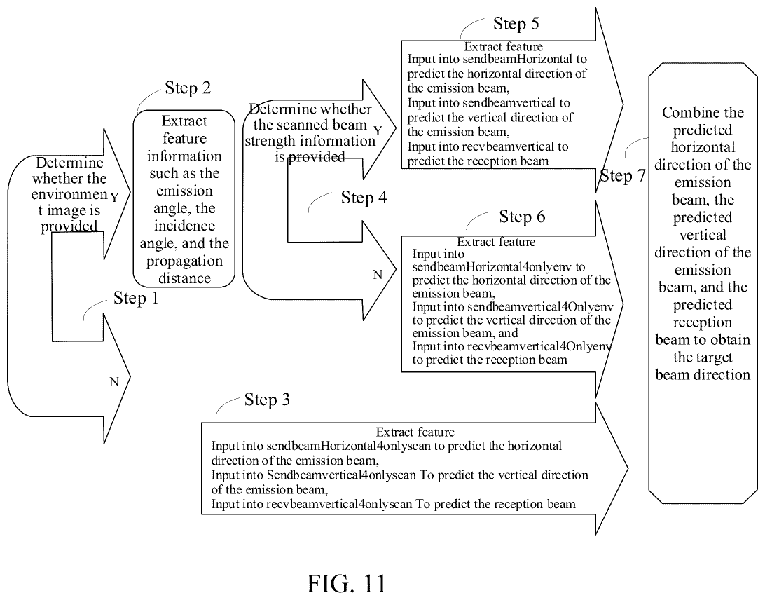

For deployment, according to whether the environmental location information and the scanned beam strength information can be obtained in the actual deployment environment, corresponding features can be extracted, and different trained models can be selected to predict the horizontal direction of the strongest emission beam, the vertical direction of the strongest emission beam, and the strongest reception beam, respectively, which can be combined as the target beam direction. FIG. 11 illustrates a schematic flowchart showing an actual deployment of an intelligent beam prediction method according to some embodiments of the present disclosure. As shown in FIG. 11, the method includes the following steps.

At step 1, whether the environment image is provided is determined.

When the environment image is provided, proceed to step 2, otherwise, proceed to step 3.

At step 2, feature information such as the emission angle, the incidence angle, and the propagation distance are extracted, and step 4 is then performed.

At step 3, the features are extracted and inputted into sendbeamHorizontal4onlyscan to predict the horizontal direction of the emission beam, sendbeamvertical4onlyscan to predict the vertical direction of the emission beam, recvbeamvertical4onlyscan to predict the reception beam, and proceed to step 7.

At step 4, whether the scanned beam strength information is provided is determined.

If the beam strength information is provided, proceed to step 5, otherwise, proceed to step 6.

At step 5, the features are extracted and inputted into sendbeamHorizontal to predict the horizontal direction of the emission beam, sendbeamvertical to predict the vertical direction of the emission beam, recvbeamvertical to predict the reception beam, and proceed to step 7.

At step 6, the features are extracted and inputted into sendbeamHorizontal4onlyenv to predict the horizontal direction of the emission beam, sendbeamvertical4onlyenv to predict the vertical direction of the emission beam, recvbeamvertical4onlyenv to predict the reception beam, and proceed to step 7.

At step 7, the predicted horizontal direction of the emission beam, the predicted vertical direction of the emission beam, and the predicted reception beam are combined to obtain the target beam direction.

In embodiments of the present disclosure, different beam prediction strategies can be used in the different scenarios. The NLOS situation can be converted into the LOS situation through the data pre-processing. Thus, when the environment image is solely used to determine the target beam direction, a large amount of resources can be saved to achieve a good effect. To solely determine the target beam direction for a certain terminal, several possible beam directions can be obtained through the location information of the environment image. Thus, the sampling process can be eliminated, and the resource consumption can be saved. In addition, the model can be created through training with a small amount of data in this method. By separating the model into the horizontal direction mode of the emission beam, the vertical direction model of the emission beam, and the reception beam model, a large amount of data can be reused, and the trained model can easily migrate, including migration between different environments and different carrier frequencies. For the situation that the beams cannot be scanned considering the system costs, and the environment image and the location information of the base station and the terminal are not able to be obtained, the corresponding model can be configured for processing. Thus, the model can have a wide application range. In practical applications, the trained machine learning model can have a fast execution speed, be small, and have small costs for resource consumption and storage, which can be conveniently deployed.

Embodiments of the present disclosure provide an intelligent beam prediction apparatus. Modules and units included in the modules of the apparatus can be implemented by the processor of the terminal or a specific logic circuit. In some embodiments, the processor can include a central processing unit, a microprocessor, a digital signal processor, or a field programmable gate array.

Embodiments of the present disclosure provide an intelligent beam prediction system. The intelligent beam prediction system can include a receiver, an emitter, and a processor. The processor can be configured to implement the above methods. The emitter can be configured to emit the target beam based on the target beam direction. The receiver can be configured to receive the target beam.

In embodiments of the present disclosure, if the above methods are implemented in the form of software functional modules and sold or used as an independent product, the methods can also be stored in a terminal-readable storage medium. Based on this understanding, the essential part of the technical solution of embodiments of the present disclosure or the part that contributes to the existing technology can be embodied in the form of a software product. The software product can be stored in a storage medium, including several instructions to make a terminal (such as a personal computer or server, etc.) execute all or a part of the methods of embodiments of the present disclosure.

Correspondingly, embodiments of the present disclosure also provide a storage medium storing executable instructions that, when executed by the processor, cause the processor to execute the methods above.

The description of the storage medium and device embodiments is similar to the description of method embodiments and has similar beneficial effects. For technical details not disclosed in storage medium and device embodiments of embodiments of the present disclosure, reference can be made to the description of method embodiments of embodiments of the present disclosure.

In embodiments of the present disclosure, the disclosed devices and methods can be implemented in other methods. The device embodiments described above are merely illustrative. For example, the division of the units can be only a logical functional division, and other divisions can be provided in practical applications. For example, a plurality of units or assemblies can be combined or integrated into another system, or some features can be ignored or not executed. Additionally, the coupling, direct coupling, or communicative connection between the displayed or discussed components can include indirect coupling or communicative connection through some interfaces, devices, or units, which can be electrical, mechanical, or other forms. The separated component can be or not be physically separated. The displayed component can be or not be a physical unit and can be located at one place or distributed at a plurality of network units. The purpose of the technical solution of the present disclosure can be implemented by selecting some or all the units as needed.

Furthermore, functional units of embodiments of the present disclosure can be integrated in a processing unit or each can be used as an individual unit. In some other embodiments, two or more units can be integrated into one unit. The integrated unit can be implemented by hardware or hardware with a software functional unit. Those skilled in the art can understand that all or some steps of the above method embodiments can be implemented through the program instructing the related hardware. The above program can be stored in a readable storage medium. When the program is executed, the steps of the method embodiments can be performed. The storage medium can include a mobile storage device, a read-only memory (ROM), a random access memory (RAM), a magnetic disc, or an optical disc that can store program codes. In some other embodiments, when the integrated unit of the present disclosure is implemented by the software function module and sold or used as the individual product, the integrated unit can also be stored in the readable storage medium. Based on this understanding, the essence of the technical solution of embodiments of the present disclosure or the part of the technical solution contributing to the existing technology can be embodied in the form of the software product. The software product can be stored in the storage medium and include several instructions used to cause the terminal to execute all or a part of the methods of embodiments of the present disclosure. The storage medium can include a mobile storage device, a read-only memory (ROM), a random access memory (RAM), a magnetic disc, or an optical disc that can store program codes. The above are some embodiments of the present disclosure. However, the present disclosure is not limited to this. Those skilled in the art can easily think of modifications or replacements within the scope of the present disclosure. The modifications and replacements are within the scope of the present disclosure. Thus, the scope of the present disclosure is subject to the scope of the appended claims.

What is claimed is:

1. An intelligent beam prediction method comprising:
obtaining an environment image, the environment image including environmental location information of a base station and a terminal;
based on the environmental location information in the environment image, determining obstacle information on a direct path from the base station to the terminal;
in response to the obstacle information indicating that an obstacle exists on the direct path, determining a target edge point of the obstacle; and
based on the target edge point, determining an emission angle, an incidence angle, and a propagation distance of a target beam between the base station and the terminal; and
based on the emission angle, the incidence angle, and the propagation distance of the target beam, determining a target beam direction.

2. The method according to claim 1, further comprising, after determining the emission angle, the incidence angle, and the propagation distance of the target beam between the base station and the terminal based on the target edge point:
determining whether beam strength information between the base station and the terminal is obtained;
in response to obtaining the beam strength information, determining a strength feature corresponding to the beam strength information; and
based on the emission angle, the incidence angle, and the propagation distance of the target beam, and the strength feature, determining the target beam direction.

3. The method according to claim 1, wherein determining the target beam direction based on the emission angle, the incidence angle, and the propagation distance of the target beam includes:
determining a horizontal direction of the emission beam, a vertical direction of the emission beam, and a reception beam based on the emission angle, the incidence angle, and the propagation distance of the target beam; and
determining the target beam direction based on the horizontal direction of the emission beam, the vertical direction of the emission beam, and the reception beam.

4. The method according to claim 1, further comprising:
in response to not obtaining an environment image, obtaining beam strength information between the base station and the terminal;
based on strength feature corresponding to the beam strength information, determining a horizontal direction of the emission beam, a vertical direction of the emission beam, and a reception beam; and
determining the target beam direction based on the horizontal direction of the emission beam, the vertical direction of the emission beam, and the reception beam.

5. The method according to claim 1, further comprising, after determining the obstacle information on the direct path from the base station to the terminal based on the environment location information:
in response to the obstacle information indicating that no obstacle is on the direct path, determining the emission angle, the incidence angle, and the propagation distance of the target beam based on the direct path.

6. The method according to claim 1, wherein in response to the obstacle information indicating that an obstacle exists on the direct path, determining the target edge point based on the obstacle includes:
determining edge points visible in a straight line from the base station to the terminal based on edge information of the obstacle; and
based on path information from each edge point to the base station and the terminal, determining the target edge point.

7. The method according to claim 1, wherein determining the emission angle, the incidence angle, and the propagation distance of the target beam between the base station and the terminal based on the target edge point includes:
determining an angle from the base station to the target edge point as the emission angle;
determining an angle from the target edge point to the terminal as the incidence angle; and
determining a sum of distances of paths from the base station to the target edge point and from the target edge point to the terminal as the propagation distance.

8. The method according to claim 1, further comprising, after obtaining the environment image:
detecting the environmental location information of the base station and the terminal; and
in response to the environmental location information changing, updating the environment image based on the environment location information.

9. The method according to claim 1, wherein determining the target beam direction based on the emission angle, the incidence angle, and the propagation distance of the target beam includes:
receiving a horizontal direction model of the emission beam, a vertical direction model of the emission beam, and a reception beam model, the horizontal direction model of the emission beam, the vertical direction model of the emission beam, and the reception beam model updating based on an emission angle, an incidence angle, and a propagation distance of a sampled beam and strength feature corresponding to the beam strength information;
inputting the emission angle, the incidence angle, and the propagation distance of the target beam and/or the strength feature corresponding to the beam strength information into the horizontal direction model of the emission beam, the vertical direction model of the emission beam, and the reception beam model to obtain a horizontal direction of the emission beam, a vertical direction of the emission beam, and a reception beam; and
based on the horizontal direction of the emission beam, the vertical direction of the emission beam, and the reception beam, determining the target beam direction.

10. An intelligent beam prediction system comprising:
a processor configured to:
obtain an environment image, the environment image including environmental location information of a base station and a terminal;
based on the environmental location information in the environment image, determine obstacle information on a direct path from the base station to the terminal;
in response to the obstacle information indicating that an obstacle exists on the direct path, determine a target edge point of the obstacle; and
based on the target edge point, determine an emission angle, an incidence angle, and a propagation distance of a target beam between the base station and the terminal; and
based on the emission angle, the incidence angle, and the propagation distance of the target beam, determine a target beam direction;
an emitter configured to emit the target beam based on the target beam direction; and
a receiver configured to receive the target beam.

11. The system according to claim 10, wherein the processor is further configured to:
determine whether beam strength information between the base station and the terminal is obtained;
in response to obtaining the beam strength information, determine a strength feature corresponding to the beam strength information; and
based on the emission angle, the incidence angle, and the propagation distance of the target beam, and the strength feature, determine the target beam direction.

12. The system according to claim 10, wherein the processor is further configured to:
determine a horizontal direction of the emission beam, a vertical direction of the emission beam, and a reception beam based on the emission angle, the incidence angle, and the propagation distance of the target beam; and
determine the target beam direction based on the horizontal direction of the emission beam, the vertical direction of the emission beam, and the reception beam.

13. The system according to claim 10, wherein the processor is further configured to:
in response to not obtaining an environment image, obtain beam strength information between the base station and the terminal;
based on strength feature corresponding to the beam strength information, determine a horizontal direction of the emission beam, a vertical direction of the emission beam, and a reception beam; and
determine the target beam direction based on the horizontal direction of the emission beam, the vertical direction of the emission beam, and the reception beam.

14. The system according to claim 10, wherein the processor is further configured to:
in response to the obstacle information indicating that no obstacle is on the direct path, determine the emission angle, the incidence angle, and the propagation distance of the target beam based on the direct path.

15. The system according to claim 10, wherein wherein the processor is further configured to:
determine edge points visible in a straight line from the base station to the terminal based on edge information of the obstacle; and
based on path information from each edge point to the base station and the terminal, determine the target edge point.

16. The system according to claim 10, wherein the processor is further configured to:
determine an angle from the base station to the target edge point as the emission angle;
determine an angle from the target edge point to the terminal as the incidence angle; and
determine a sum of distances of paths from the base station to the target edge point and from the target edge point to the terminal as the propagation distance.

17. The system according to claim 10, wherein the processor is further configured to:
detect the environmental location information of the base station and the terminal; and
in response to the environmental location information changing, update the environment image based on the environment location information.

18. The system according to claim 10, wherein the processor is further configured to:
receive a horizontal direction model of the emission beam, a vertical direction model of the emission beam, and a reception beam model, the horizontal direction model of the emission beam, the vertical direction model of the emission beam, and the reception beam model updating based on an emission angle, an incidence angle, and a propagation distance of a sampled beam and strength feature corresponding to the beam strength information;
input the emission angle, the incidence angle, and the propagation distance of the target beam and/or the strength feature corresponding to the beam strength information into the horizontal direction model of the emission beam, the vertical direction model of the emission beam, and the reception beam model to obtain a horizontal direction of the emission beam, a vertical direction of the emission beam, and a reception beam; and
based on the horizontal direction of the emission beam, the vertical direction of the emission beam, and the reception beam, determine the target beam direction.
